(19) United States
(12) Patent Application Publication
(10) Pub. No.: US 2011/0259747 A1
(43) Pub. Date: Oct. 27, 2011

(54) WATER STERILIZATION DEVICES INCLUDING NANOSTRUCTURES AND USES THEREOF

(75) Inventors: Yi Cui, Stanford, CA (US); Sarah Heilshorn, Mountain View, CA (US); Liangbing Hu, Mountain View, CA (US); Alia Schoen, East Palo Alto, CA (US); David Schoen, East Palo Alto, CA (US)

(73) Assignee: The Board of Trustees of the Leland Stanford Junior University, Palo Alto, CA (US)

(21) Appl. No.: 13/092,883

(22) Filed: Apr. 22, 2011

Related U.S. Application Data
(60) Provisional application No. 61/343,127, filed on Apr. 23, 2010.

(51) Int. Cl. B03C 5/02; C02F 1/48

(52) U.S. Cl. 204/554; 204/674

(57) ABSTRACT

A water sterilization device includes: (1) a conduit including an inlet to provide entry of untreated water and an outlet to provide exit of treated water; (2) a porous electrode housed in the conduit and disposed between the inlet and the outlet, the porous electrode including a porous support and nanostructures coupled to the porous support; and (3) an electrical source coupled to the porous electrode.

### CROSS REFERENCE TO RELATED APPLICATION

This application claims the benefit of U.S. Provisional Application No. 61/343,127, filed on Apr. 23, 2010, the disclosure of which is incorporated herein by reference in its entirety.

### FIELD OF THE INVENTION

The invention relates generally to sterilization of fluids. More particularly, the invention relates to water sterilization devices including nanostructures and uses thereof

### BACKGROUND

The removal of bacteria and other harmful organisms from water is an important process, not only for drinking and sanitation but also industrially as biofouling is a commonplace and serious problem. Conventional approaches for water sterilization include chlorination and membrane-based approaches. Unfortunately, both of these types of approaches suffer from certain deficiencies.

Chlorination is typically a slow process, involving incubation times up to an hour or more to allow Cl⁻ions to adequately dissipate through water to be treated. Also, chlorination can yield hazardous oxidation byproducts, including carcinogenic species, and chlorination equipment can be capital intensive, both from the standpoint of deployment and maintenance.

Conventional membrane-based approaches typically operate based on size exclusion of bacteria, which can involve a high pressure drop across a membrane and clogging of the membrane. Moreover, conventional membrane-based approaches can be energy intensive, and can suffer from low flow rates across a membrane.

It is against this background that a need arose to develop the water sterilization devices and related methods and systems described herein.

### SUMMARY

One aspect of the invention relates to a water sterilization device. In one embodiment, the device includes: (1) a conduit including an inlet to provide entry of untreated water and an outlet to provide exit of treated water; (2) a porous electrode housed in the conduit and disposed between the inlet and the outlet, the porous electrode including a porous support and nanostructures coupled to the porous support; and (3) an electrical source coupled to the porous electrode.

Another aspect of the invention relates to a method of sterilization. In one embodiment, the method includes: (1) providing a fibrous material and nanostructures coupled to the fibrous material, at least one of the nanostructures including a metal and having an aspect ratio that is at least 5; and (2) passing a fluid stream through the fibrous material, so as to at least partially sterilize the fluid stream based on exposure to the nanostructures.

Other aspects and embodiments of the invention are also contemplated. The foregoing summary and the following detailed description are not meant to restrict the invention to any particular embodiment but are merely meant to describe some embodiments of the invention.

### BRIEF DESCRIPTION OF THE DRAWINGS

For a better understanding of the nature and objects of some embodiments of the invention, reference should be made to the following detailed description taken in conjunction with the accompanying drawings.

FIG. 1 illustrates a water sterilization device implemented in accordance with an embodiment of the invention.

FIG. 2 is a magnified view of a porous structure implemented in accordance with an embodiment of the invention.

FIG. 3 illustrates a water filtration system implemented in accordance with an embodiment of the invention.

FIG. 4 illustrates a water sterilization device implemented in accordance with another embodiment of the invention.

FIG. 5 illustrates a water sterilization device implemented in accordance with yet another embodiment of the invention.

FIG. 6 illustrates a gravity-fed, porous structure implemented in accordance with an embodiment of the invention.

FIG. 7 illustrates the performance of a porous structure as a function of applied voltage, according to an embodiment of the invention.

FIG. 8(A) illustrates the performance of a porous structure over time, according to an embodiment of the invention.

FIG. 8(B) illustrates the performance of a porous structure as a function of bacterial density, according to an embodiment of the invention.

FIG. 9 illustrates inactivation efficacy for different filtration path lengths and different porous structures, according to an embodiment of the invention.

FIG. 10 compares inactivation efficacy of porous structures with silver nanowires relative to porous structures without silver nanowires, according to an embodiment of the invention.

FIG. 11(A) and FIG. 11B illustrate finite element simulations of electric field intensity in the vicinity of a nanowire, according to an embodiment of the invention.

### DETAILED DESCRIPTION

### Definitions

The following definitions apply to some of the aspects described with respect to some embodiments of the invention. These definitions may likewise be expanded upon herein.

As used herein, the singular terms “a,” “an,” and “the” include plural referents unless the context clearly dictates otherwise. Thus, for example, reference to an object can include multiple objects unless the context clearly dictates otherwise.

As used herein, the term “set” refers to a collection of one or more objects. Thus, for example, a set of objects can include a single object or multiple objects. Objects of a set also can be referred to as members of the set. Objects of a set can be the same or different. In some instances, objects of a set can share one or more common characteristics.

As used herein, the term “adjacent” refers to being near or adjoining Adjacent objects can be spaced apart from one another or can be in actual or direct contact with one another. In some instances, adjacent objects can be coupled to one another or can be formed integrally with one another.

As used herein, the terms “couple,” “coupled,” and “coupling” refer to an operational connection or linking. Coupled objects can be directly connected to one another or can be indirectly connected to one another, such as via an intermediary set of objects.

As used herein, the terms “substantially” and “substantial” refer to a considerable degree or extent. When used in conjunction with an event or circumstance, the terms can refer to instances in which the event or circumstance occurs precisely as well as instances in which the event or circumstance occurs to a close approximation, such as accounting for typical tolerance levels or variability of the embodiments described herein.

As used herein, the terms “expose,” “exposing,” and “exposed” refer to a particular object being subject to some level of interaction with another object. A particular object can be exposed to another object without the two objects being in actual or direct contact with one another. Also, a particular object can be exposed to another object via indirect interaction between the two objects, such as via an intermediary set of objects.

As used herein, the term “nanometer range” or “nm range” refers to a range of dimensions from about 1 nm to about 1 micrometer (“μm”). The nm range includes the “lower nm range,” which refers to a range of dimensions from about 1 nm to about 10 nm, the “middle nm range,” which refers to a range of dimensions from about 10 nm to about 100 nm, and the “upper nm range,” which refers to a range of dimensions from about 100 nm to about 1 μm.

As used herein, the term “micrometer range” or “μm range” refers to a range of dimensions from about 1 μm to about 1 mm. The μm range includes the “lower μm range,” which refers to a range of dimensions from about 1 μm to about 10 μm, the “middle μm range,” which refers to a range of dimensions from about 10 μm to about 100 μm, and the “upper μm range,” which refers to a range of dimensions from about 100 μm to about 1 mm.

As used herein, the term “aspect ratio” refers to a ratio of a largest dimension or extent of an object and an average of remaining dimensions or extents of the object, where the remaining dimensions are orthogonal with respect to one another and with respect to the largest dimension. In some instances, remaining dimensions of an object can be substantially the same, and an average of the remaining dimensions can substantially correspond to either of the remaining dimensions. For example, an aspect ratio of a cylinder refers to a ratio of a length of the cylinder and a cross-sectional diameter of the cylinder. As another example, an aspect ratio of a spheroid refers to a ratio of a major axis of the spheroid and a minor axis of the spheroid.

As used herein, the term “nanostructure” refers to an object that has at least one dimension in the nm range. A nanostructure can have any of a wide variety of shapes, and can be formed of a wide variety of materials. Examples of nanostructures include nanowires, nanotubes, and nanoparticles.

As used herein, the term “nanowire” refers to an elongated nanostructure that is substantially solid. Typically, a nanowire has a lateral dimension (e.g., a cross-sectional dimension in the form of a width, a diameter, or a width or diameter that represents an average across orthogonal directions) in the nm range, a longitudinal dimension (e.g., a length) in the μm range, and an aspect ratio that is about 5 or greater.

As used herein, the term “nanotube” refers to an elongated, hollow nanostructure. Typically, a nanotube has a lateral dimension (e.g., a cross-sectional dimension in the form of a width, an outer diameter, or a width or outer diameter that represents an average across orthogonal directions) in the nm range, a longitudinal dimension (e.g., a length) in the μm range, and an aspect ratio that is about 5 or greater.

As used herein, the term “nanoparticle” refers to a spheroidal nanostructure. Typically, each dimension (e.g., a cross-sectional dimension in the form of a width, a diameter, or a width or diameter that represents an average across orthogonal directions) of a nanoparticle is in the nm range, and the nanoparticle has an aspect ratio that is less than about 5, such as about 1.

### Water Sterilization Devices

Embodiments of the invention relate to the sterilization of water or other fluids using a porous structure that can effectively inactivate bacteria and other undesired organisms. Certain embodiments incorporate nanostructures in a porous support to yield an electrically conductive and high surface area structure for the active, high-throughput inactivation of bacteria in water. Notably, unlike conventional membrane-based approaches, a porous structure described herein need not rely on size exclusion of bacteria, which can involve a high pressure drop and can lead to clogging, but instead combines components spanning multiple length scales into an active nanoscale architecture that inactivates bacteria passing through the porous structure. In some embodiments, the use of such a porous structure leads to a gravity-fed, biofouling-resistant device that can inactivate bacteria at faster flow rates than conventional membrane-based approaches while consuming less energy. In addition, such improved performance can be achieved with short incubation times and without requiring the use of chemical additives as in chlorination.

As noted above, one component of a porous structure is a porous support, which can be characterized in terms of its material composition, its pore size, and its porosity. Depending on the particular implementation, a porous support can be formed of a material that is insulating, electrically conductive, or semiconducting, or can be formed of a combination of materials having a combination of characteristics. In some embodiments, a porous support includes a fibrous material, namely one including a matrix or a network of fibers that can be woven or unwoven. Examples of fibrous materials include paper and textiles, including those formed of natural fibers, such as cotton, flax, and hemp, and those formed of synthetic fibers, such as acrylic, polyester, rayon, as well as carbon fiber in the form of a carbon cloth. Other types of porous supports are contemplated, such as permeable or semi-permeable membranes, sponges, and meshes formed of metals or other electrically conductive materials.

A pore size of a porous support can be selected based on a typical size of organisms to be inactivated. For example, in the case of bacteria, a pore size can be selected to be greater than a typical size of bacteria to be inactivated, thereby allowing passage of bacteria with little or no clogging of a porous support. In some embodiments, a porous support can include pores that are sufficiently sized in the μm range, such as at least about 5 μm or at least about 10 μm and up to about 1 mm, and, more particularly, a pore size can be in the range of about 5 μm to about 900 μm, about 10 μm to about 800 μm, about 10 μm to about 700 μm, about 10 μm to about 600 μm, about 10 μm to about 500 μm, about 20 μm to about 400 μm, about 30 μm to about 300 μm, about 40 μm to about 300 μm, about 50 μm to about 300 μm, or about 50 μm to about 200 μm. In the case of other types of organisms, a pore size can be suitably selected in accordance with a typical size of those organisms. For example, in the case of viruses, a pore size can be selected to be in the nm range, such as at least about 100 nm and up to about 1 μm. As can be appreciated, pores of a porous support can have a distribution of sizes, and a pore size can refer to an effective size across the distribution of sizes or an average or median of the distribution of sizes. An example of a technique for determining pore size is the so-called “challenge test,” in which spheroidal particles of known size distributions are presented to a porous support and changes downstream are measured by a particle size analyzer. Using the challenge test, a pore size can be determined from a calibration graph, with the pore size corresponding to an effective cut-off point of the porous support. In some implementations, this cut-off point can correspond to a maximum size of a spheroidal particle that can pass through substantially unblocked by the porous support.

Another characterization of a porous support is its porosity, which is a measure of the extent of voids resulting from the presence of pores or any other open spaces in the porous support. A porosity can be represented as a ratio of a volume of voids relative to a total volume, namely between 0 and 1, or as a percentage between 0% and 100%. In some embodiments, a porous support can have a porosity that is at least about 0.05 or at least about 0.1 and up to about 0.95, and, more particularly, a porosity can be in the range of about 0.1 to about 0.9, about 0.2 to about 0.9, about 0.3 to about 0.9, about 0.4 to about 0.9, about 0.5 to about 0.9, about 0.5 to about 0.8, or about 0.6 to about 0.8. Techniques for determining porosity include, for example, porosimetry and optical or scanning techniques.

As noted above, another component of a porous structure corresponds to nanostructures, which are incorporated in a porous support to impart desired functionality to the resulting porous structure. Depending on the particular implementation, a single type of nanostructure can be incorporated, or two or more different types of nanostructures can be incorporated to impart a combination of functionalities.

A nanostructure can be characterized in terms of its material composition, its shape, and its size. Depending on the particular implementation, a nanostructure can be formed of a material that is insulating, electrically conductive, or semiconducting, or can be a heterostructure formed of a combination of materials having a combination of characteristics, such as in a core-shell or multi-layered configuration. Techniques for forming nanostructures include, for example, attrition, spray pyrolysis, hot injection, laser ablation, and solution-based synthesis. In some embodiments, a porous structure provides sterilization via an electrical mechanism, with a high surface area of a porous support and nanostructures along with an induced electric field in the vicinity of the nanostructures providing effective bacterial inactivation. In the case that the porous support is insulating, at least a subset of the nanostructures can be electrically conductive or semiconducting to impart electrical conductivity to the porous structure. For example, a nanostructure can be formed of a metal, a metal alloy, a metal silicide, a metal oxide, a semiconductor, an electrically conductive polymer, a doped form of such materials, or a combination of such materials, and, more particularly, a nanostructure can be formed of copper, gold, nickel, palladium, platinum, silver, carbon (e.g., in the form of a graphene) or another Group IVB element (e.g., silicon or germanium), a Group IVB-IVB binary alloy (e.g., silicon carbide), a Group IIB-VIB binary alloy (e.g., zinc oxide), a Group IIIB-VB binary alloy (e.g., aluminum nitride), or another binary, ternary, quaternary, or higher order alloy of Group IB (or Group 11) elements, Group IIB (or Group 12) elements, Group IIIB (or Group 13) elements, Group IVB (or Group 14) elements, Group VB (or Group 15) elements, Group VIB (or Group 16) elements, and Group VIIB (or Group 17) elements. In the case that a porous support is electrically conductive, nanostructures that are electrically conductive or semiconducting optionally can be omitted.

In addition to, or in place of, sterilization via an electrical mechanism, sterilization can be achieved through the use of a material having an intrinsic activity towards inactivating bacteria or other undesired organisms. For example, at least a subset of incorporated nanostructures can be formed of a material or a combination of materials having intrinsic antimicrobial activity, such as silver (or another noble metal), copper, nickel, or another bactericidal material. The use of nanostructures formed of a metal such as silver can serve a dual purpose of imparting an electrical conduction functionality as well as a bactericidal functionality to a resulting porous structure.

A nanostructure can have any of a variety of shapes, such as spheroidal, tetrahedral, tripodal, disk-shaped, pyramid-shaped, box-shaped, cube-shaped, cylindrical, tubular, and a number of other geometric and non-geometric shapes. Examples of nanostructures include fullerenes, copper nanowires, nickel nanowires, silver nanowires, germanium nanowires, silicon nanowires, carbon nanotubes (e.g., single-walled carbon nanotubes and multi-walled carbon nanotubes), and core-shell nanowires (e.g., a shell formed of copper, nickel, or silver surrounding a core formed of another material). In some embodiments, at least a subset of incorporated nanostructures corresponds to high aspect ratio nanostructures, such as nanotubes, nanowires, or a combination of nanotubes and nanowires. High aspect ratio nanostructures can have large surface areas for stronger and direct coupling to constituent fibers of a porous support, without requiring chemical strategies to provide such coupling. In addition, the use of high aspect ratio nanostructures can increase the occurrence of junction formation between neighboring nanostructures, and can form an efficient charge transport network by reducing the number of hopping or tunneling events, relative to the use of nanoparticles. However, it is contemplated that nanoparticles can be used in combination with, or in place of, high aspect ratio nanostructures.

For example, a porous structure can include nanowires, such as silver nanowires, having an average or median diameter in the range of about 1 nm to about 200 nm, about 1 nm to about 150 nm, about 10 nm to about 100 nm, about 20 nm to about 100 nm, about 30 nm to about 100 nm, or about 40 nm to about 100 nm, an average or median length in the range of about 500 nm to about 100 μm, about 800 nm to about 50 nm, about 1 μm to about 40 μm, about 1 μm to 30 μm, about 1 μm to about 20 μm, or about 1 μm to about 10 μm, and an average or median aspect ratio in the range of about 5 to about 2,000, about 50 to about 1,000, about 100 to about 900, about 100 to about 800, about 100 to about 700, about 100 to about 600, or about 100 to about 500.

As another example, a porous structure can include nanotubes, such as carbon nanotubes, having an average or median diameter (e.g., outer diameter) in the range of about 1 nm to about 200 nm, about 1 nm to about 150 nm, about 10 nm to about 100 nm, about 20 nm to about 100 nm, about 30 nm to about 100 nm, or about 40 nm to about 100 nm, an average or median length in the range of about 500 nm to about 100 μm, about 800 nm to about 50 m, about 1 μm to about 40 μm, about 1 μm to 30 μm, about 1 μm to about 20 μm, or about 1 μm to about 10 μm, and an average or median aspect ratio in the range of about 5 to about 2,000, about 50 to about 1,000, about 100 to about 900, about 100 to about 800, about 100 to about 700, about 100 to about 600, or about 100 to about 500.

In embodiments in which sterilization is achieved via an electrical mechanism, a porous structure can have a sheet resistance that is no greater than about 1,000 Ω/sq, no greater than about 500 Ω/sq, no greater than about 400 Ω/sq, no greater than about 300 Ω/sq, no greater than about 200 Ω/sq, no greater than about 100 Ω/sq, no greater than about 50 Ω/sq, no greater than about 25 Ω/sq, or no greater than about 10 Ω/sq, and down to about 1 Ω/sq, down to about 0.1 Ω/sq, or less.

Incorporation of nanostructures in a porous support can be carried out in a variety of ways. For example, nanostructures can be formed and then dispersed in an aqueous solution or a non-aqueous solution to form an ink. Surfactants, dispersants, and other additives to adjust rheology also can be included. Next, the ink including the dispersed nanostructures can be applied to a porous support using any of a number of coating techniques, such as spraying, printing, roll coating, curtain coating, gravure coating, slot-die, cup coating, blade coating, immersion, dip coating, and pipetting, followed by drying or other removal of the solution. It is also contemplated that nanostructures can be formed in situ on a porous support, such as by exposing surfaces of the porous support to a precursor solution.

Coupling between nanostructures and a porous support can rely on mechanical entanglement of the nanostructures within pores of the porous support, adhesion characteristics of an ink relative to constituent fibers of the porous support, surface charges of the constituent fibers, functional groups of the constituent fibers, or a combination of these mechanisms. In some embodiments, coupling between nanostructures and a porous support can involve the formation of chemical bonds, including covalent bonds and non-covalent bonds, such as van der Waals interactions, hydrogen bonds, bonds based on hydrophobic forces, bonds based on π-π interactions, and bonds based on electrostatic interactions (e.g., between cations and anions or dipole-dipole interactions). It is contemplated that nanostructures can be functionalized or otherwise treated to promote the formation of chemical bonds.

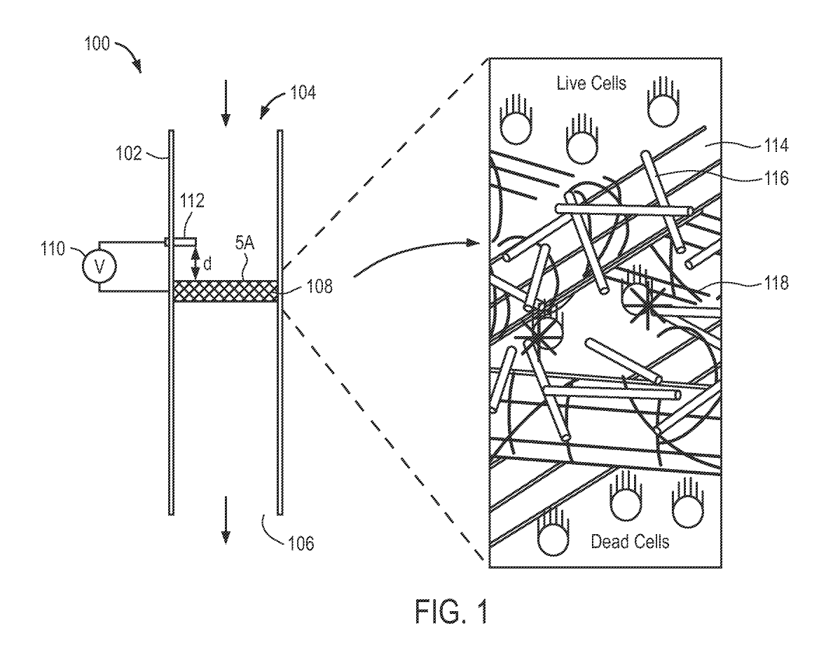

Attention turns to FIG. 1, which illustrates a water sterilization device 100 implemented in accordance with an embodiment of the invention. The device 100 includes a conduit 102 that provides a passageway for a fluid stream to be treated. In the illustrated embodiment, the fluid stream is a stream of water to be sterilized, and the conduit 102 includes an inlet 104, which allows entry of untreated water, and an outlet 106, which allows exit of treated water.

The device 100 also includes a porous structure 108, which is housed in the conduit 102 and is disposed between the inlet 104 and the outlet 106. During operation of the device 100, a stream of water passes through the porous structure 108 and is sterilized upon passing through pores of the porous structure 108. Although the single porous structure 108 is illustrated in FIG. 1, it is contemplated that multiple porous structures can be included to provide multi-staged, serial sterilization of a fluid stream.

In the illustrated embodiment, sterilization is at least partially achieved via an electrical mechanism, with the porous structure 108 serving as a porous electrode. Specifically, the device 100 further includes a counter electrode 112 and an electrical source 110, which is coupled to the porous structure 108 and the counter electrode 112. The counter electrode 112 is housed in the conduit 102 and is spaced apart from the porous structure 108 by a distance d, which can be at least about 5 μm, at least about 10 μm, or at least about 100 μm, and up to about 200 μm, up to about 500 μm, up to about 1 cm, or up to about 10 cm. The electrical source 110 can be implemented as a voltage source that applies a voltage difference between the porous structure 108 and the counter electrode 112, such as a voltage difference in the range of about −100 V to about +100 V, about −80 V to about +80 V, about −50 V to about +50 V, about −30 V to about +30 V, about −20 V to about +20 V, about −10 V to about +10 V, or about −5 V to about +5 V. The application of a voltage induces an electric field in the vicinity of the porous structure 108, and a stream of water is at least partially sterilized as it passes through the porous structure 108 and is subjected to the electric field.

As illustrated in FIG. 1, the porous structure 108 includes multiple components spanning multiple length scales to provide a combination of functionalities. A fibrous material, including constituent fibers 114, serves as a backbone of the porous structure 108. For example, the fibrous material can be a cotton-based textile, in which the fibers 114 have an average or median diameter on the order of a few tens of micrometers, and in which pores between the fibers 114 are in the range of tens to hundreds of micrometers, which are larger than a typical size of bacteria to avoid or reduce clogging during operation.

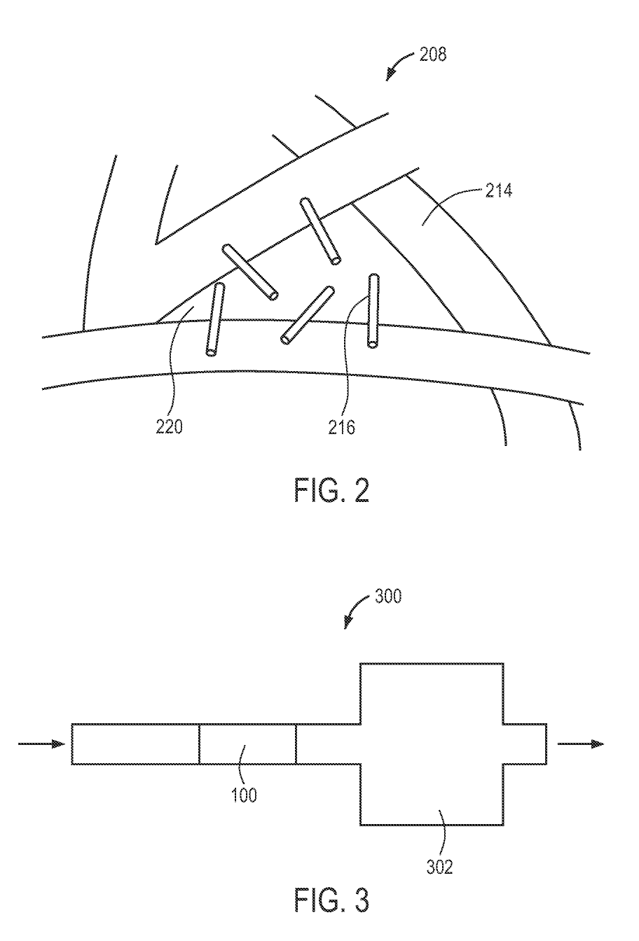

Another component of the porous structure 108 corresponds to nanowires 116, such as silver nanowires with an average or median diameter in the range of about 40 nm to about 100 nm and an average or median length in the range of about 1 μm to about 10 μm. The nanowires 116 can provide a secondary mesh as illustrated in FIG. 1. Silver nanowires can be desirable, since silver is an effective bactericidal agent. In addition, each silver nanowire can have multiple contact points for strong coupling to the fibers 114. Moreover, silver nanowires can form an efficient, interconnected charge transport network, and intense electric fields due to nanoscale diameter of the silver nanowires can be exploited for highly effective bacterial inactivation. In the illustrated embodiment, the nanowires 116 are conformally coated onto the fibers 114, such that long axes of the nanowires 116, on average, are generally parallel to coupling surfaces of the fibers 114. The orientation of the nanowires 116 can be varied for other implementations. For example, FIG. 2 illustrates a porous structure 208 implemented in accordance with another embodiment of the invention, in which nanowires 216 at least partially extend into a pore 220 between fibers 214 so as to reduce an effective size of the pore 220. As illustrated in FIG. 2, long axes of the nanowires 216, on average, are generally orthogonal to coupling surfaces of the fibers 214. The nanowires 216 can be formed in situ on the fibers 214, and their rigidity can maintain their generally orthogonal orientation relative to the fibers 214.

Turning back to FIG. 1, the next component of the porous structure 108 corresponds to nanotubes 118, such as carbon nanotubes. The nanotubes 118 are conformally coated onto the fibers 114 to impart electrical conductivity over most, or all, of an active surface area SA of the porous structure 108. In such manner, the porous structure 108 can be placed at a controlled electric potential and used in solution as a porous electrode. The interconnected configuration of the nanowires 116 also can contribute towards electrical conductivity of the porous structure 108. The orientation of the nanotubes 118 can be varied for other implementations, such as in the manner illustrated in FIG. 2.

Referring to FIG. 1, the device 100 is implemented as a gravity-fed device, and can operate at a flow rate in the range of about 50,000 L/(hr m²) to about 200,000 L/(hr m²), about 50,000 L/(hr m²) to about 150,000 L/(hr m²), or about 80,000 L/(hr m²) to about 120,000 L/(hr m²), accounting for the surface area SA of the porous structure 108. High-throughput inactivation of bacteria and other undesired organisms can be achieved by gravity feeding through the porous structure 108 that is placed at a moderate voltage for low power consumption. For example, operation of the device 100 can yield a bacterial inactivation efficiency that is at least about 60%, at least about 70%, at least about 80%, at least about 85%, at least about 90%, at least about 95%, or at least about 98%, and up to about 99%, up to about 99.5%, up to about 99.9%, or more. Such inactivation efficiency can be achieved with a short incubation time, such as in the range of about 0.1 sec to about 1 min, about 0.1 sec to about 50 sec, about 0.5 sec to about 40 sec, about 0.5 sec to about 30 sec, about 0.5 sec to about 20 sec, about 0.5 sec to about 10 sec, or about 0.5 sec to about 5 sec. In terms of balancing performance versus power consumption, it is contemplated that a pump or other flow control mechanism (not illustrated in FIG. 1) can be included to increase inactivation throughput of the device 100. It is also contemplated that the electrical source 110 can be an oscillating source for further improvements in inactivation efficiency, such by inducing an alternating electric field at a frequency in the range of about 1 kHz to about 1,000 kHz, about 10 kHz to about 1,000 kHz, or about 100 kHz to about 1,000 kHz.

Without wishing to be bound by a particular theory, bacterial inactivation can be achieved in accordance with any one, or a combination, of the following mechanisms.

First, silver is an intrinsic bactericidal material, and exposure of bacteria in untreated water to silver nanowires (or nanostructures formed of another bactericidal material) can lead to inactivation of the bacteria. Second, the application of a voltage to the porous structure 108 can yield an electric field of sufficient intensity to adversely impact cell viability, by breaking down cell membranes via electroporation. Third, changes to solution chemistry in the presence of an electric field or a current flow, including pH changes as well as in situ formation of bactericidal species, can be another mechanism of sterilization. As noted above, two or more of these mechanisms can operate in concert to inactivate bacteria.

The device 100 can be operated as a point-of-use water filter for deactivating pathogens in water. Alternatively, and as illustrated in FIG. 3, the device 100 can be incorporated in a water filtration system 300, serving as an upstream unit to deactivate organisms that can cause biofouling in a downstream filtration unit 302, such as a reverse osmosis unit in a water desalination plant. The device 100 and other implementations described herein can dramatically lower the operational cost of a wide array of filtration technologies for water as well as food, air, and pharmaceuticals, by reducing the occurrence of biofouling and, therefore, reducing the frequency at which downstream filters are replaced.

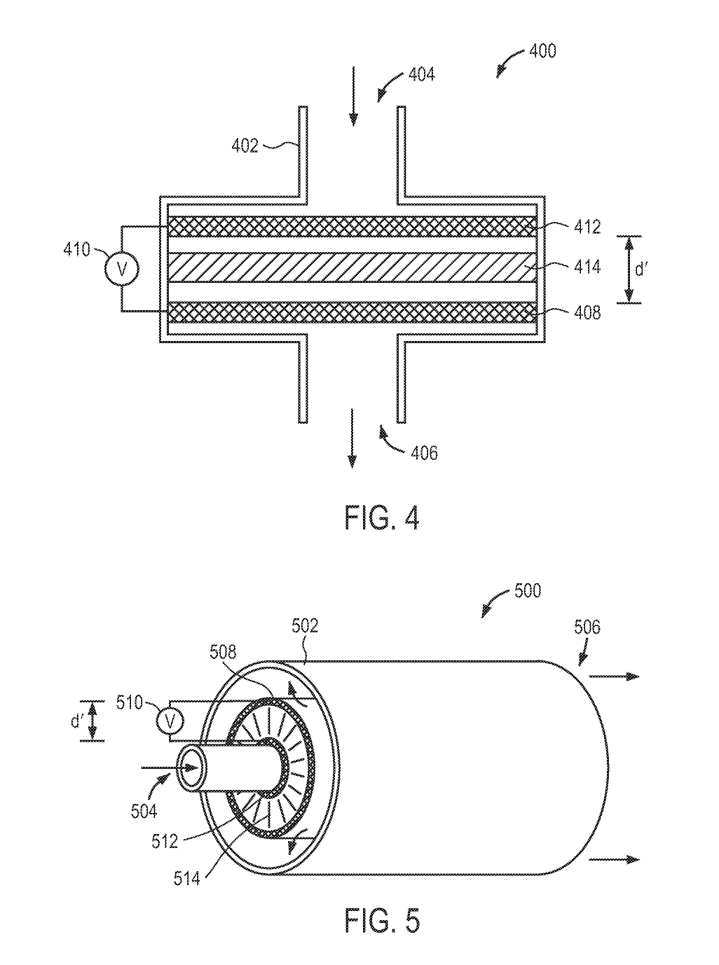

FIG. 4 illustrates a water sterilization device 400 implemented in accordance with another embodiment of the invention. The device 400 includes a conduit 402, which includes an inlet 404 and an outlet 406. The device 400 also includes a porous electrode 408, which is housed in the conduit 402 and is disposed between the inlet 404 and the outlet 406, and an electrical source 410, which is coupled to the porous electrode 408. Certain aspects of the device 400 can be implemented in a similar manner as previously described with reference to FIG. 1 through FIG. 3, and those aspects are not repeated below.

Referring to FIG. 4, the device 400 includes another porous electrode 412, which is coupled to the electrical source 410. The porous electrode 412 is housed in the conduit 402 and is spaced apart from the porous electrode 408 by a distance d′, which can be at least about 5 μm, at least about 10 μm, or at least about 100 μm, and up to about 200 μm, up to about 500 μm, up to about 1 cm, or up to about 10 cm. A separator 414, which is formed of a porous, insulating material, is disposed between the porous electrodes 408 and 412 to maintain a desired spacing between the porous electrodes 408 and 412 and to prevent electrical shorts. The porous electrodes 408 and 412 can be similarly implemented, or can differ in at least one component, such as in terms of their constituent porous supports, their constituent nanostructures, or both. During operation of the device 400, a stream of water passes through the porous electrodes 408 and 412 and is sterilized upon passing through pores of the porous electrodes 408 and 412. In the illustrated embodiment, sterilization is at least partially achieved via an electrical mechanism, and the electrical source 410 applies a voltage difference between the porous electrodes 408 and 412, such that the stream of water is subjected to an electric field. The inclusion of the pair of porous electrodes 408 and 412 provides two-staged, serial sterilization of the stream of water, and can yield further improvements in bacterial inactivation efficiency, such as at least about 95% or at least about 98%, and up to about 99%, up to about 99.5%, up to about 99.9%, or more.

FIG. 5 illustrates a water sterilization device 500 implemented in accordance with yet another embodiment of the invention. The device 500 includes a conduit 502, which includes an inlet 504 and an outlet 506. Housed in the conduit 502 are a pair of porous electrodes 508 and 512, which are coupled to an electrical source 510, and a separator 514, which is disposed between the porous electrodes 508 and 512. Certain aspects of the device 500 can be implemented in a similar manner as previously described with reference to FIG. 1 through FIG. 4, and those aspects are not repeated below.

As illustrated in FIG. 5, the conduit 502, the porous electrodes 508 and 512, and the separator 514 each have a substantially tubular shape, with the separator 514 concentrically disposed adjacent to an exterior surface of the porous electrode 512, and with the porous electrode 508 concentrically disposed adjacent to an exterior surface of the separator 514. During operation of the device 500, a stream of water initially passes through the porous electrode 512, next passes through the separator 514, next passes through the porous electrode 508, and then exits the device 500 through a gap between the conduit 502 and the porous electrode 508. It is also contemplated that the flow direction can be reversed for another implementation.

### EXAMPLES

The following examples describe specific aspects of some embodiments of the invention to illustrate and provide a description for those of ordinary skill in the art. The examples should not be construed as limiting the invention, as the examples merely provide specific methodology useful in understanding and practicing some embodiments of the invention.

### Example 1

### Formation of Water Sterilization Device

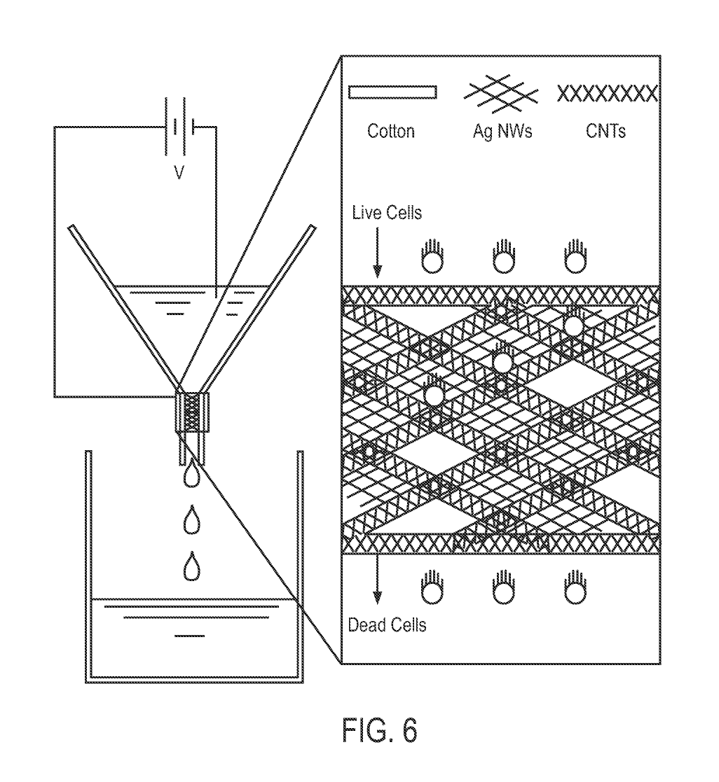

A gravity-fed, porous structure was implemented as illustrated in FIG. 6, and included a cotton-based textile, silver nanowires (“AgNWs”), and carbon nanotubes (“CNTs”). AgNWs were synthesized by first reducing 25 mg of AgCl in 330 mg of poly(vinylpyridine) in 20 mL of ethylene glycol at 170° C. under vigorous stirring, followed by dropwise addition of 110 mg of AgNO₃ dissolved in 10 mL of ethylene glycol over 10 min. After synthesis, the AgNWs were transferred into methanol by two operations of centrifugation at 6000 rpm for 20 min each. An aqueous CNT ink was prepared by dispersing 1.6 mg/mL laser ablation CNTs in water with 10 mg/mL sodium dodecylbenzenesulfonate (“SDBS”) as a surfactant. A cotton-based textile was coated with the CNTs by submerging the textile in the aqueous CNT ink. Of note, a single dip rendered the textile electrically conductive, with a measured sheet resistance of about 100 Ω/sq. The textile was then rinsed well in distilled water to remove excess surfactant. The AgNWs were added to the electrically conductive textile by pipetting the AgNWs directly from the methanol solution, followed by drying on a hot plate at 95° C. for 30 min and copious rinsing to remove any excess solvent and surfactant. The resulting porous structure was flexible and mechanically robust, with an even lower sheet resistance of about 1 Ω/sq. The structure can be mechanically manipulated for integration into a final filtering system, which in this example involved insertion of the structure into a gravity-fed, glass funnel and coupling to a voltage source.

### Example 2

### Characterization of Water Sterilization Device

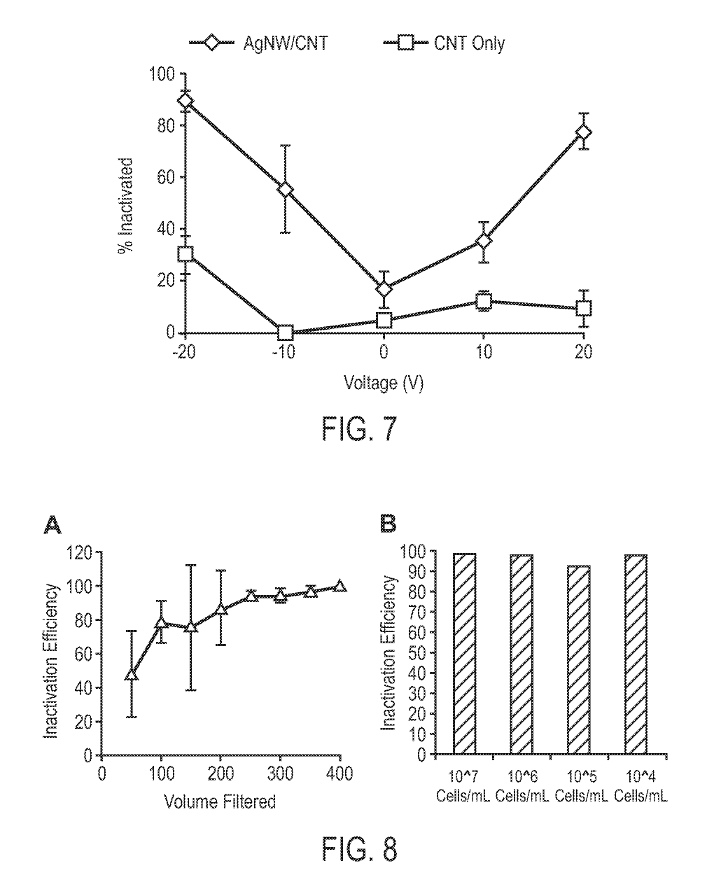

FIG. 7 illustrates the performance of a porous structure, which included AgNWs, CNTs, and a cotton-based textile of 4 mm in diameter and 2.5 cm in length, and was operated under gravity feed at a flow rate of 1 L/hr. This flow rate corresponds to 80,000 L/(hr m²) when adjusted for size, compared to a typical value of about 1 L/(hr m²) for a nanofibrous size exclusion membrane operated at 130 psi. The efficacy of the structure for inactivating bacteria was assessed by dispersing treated solution onto an agar plate, which is a substrate that includes nutrients and attachment sites for the bacteria. After dispersal, the plates were incubated at 37° C. overnight. Each healthy cell in the plated solution multiplies and generates a colony of bacteria after incubation. The resulting colonies can be visually detected, so that the number of healthy bacteria in the initial treated solution can be counted and compared to that of an untreated sample of the same solution. For each measurement, 100 mL of solution with nominal Escherichia coli density of 10⁷ bacteria/mL was flowed through the structure. Treated solution was diluted 1,000 times, and 100 μL was plated. The structure was operated at five separate biases from −20 V to +20 V, and a Cu mesh counter electrode held at ground was present in solution separated by about 1 cm from the structure. The results for the AgNW/CNT/cotton structure are compared to that of a structure including CNTs and cotton (but without AgNWs) in FIG. 7. At 0 V, neither structure effectively removes bacteria. However, at −20 V, the AgNW/CNT/cotton structure inactivated 89% of the bacteria, while, at +20 V, the AgNW/CNT/cotton structure inactivated 77% of the bacteria. The CNT-only structure exhibited lesser performance at all voltages tested, indicating the contribution of AgNWs for effective bacterial inactivation. In FIG. 7, the total error bar dimension represents one standard deviation over three tested samples for the AgNW/CNT/cotton structure and four tested samples for the CNT-only structure.

Over the scale of volumes tested, the performance of a water sterilization device remains robust with time. FIG. 8(A) illustrates the performance of a porous structure over time. Two separate flow experiments in identical conditions, with a 1 L/hr flow rate and initial Escherichia coli density of 10⁷ bacteria/mL, were carried out, and samples of solution were taken every 15 seconds. 100 μL of 1,000 times diluted solution was plated onto an agar plate and compared to growth of untreated solution. Points represent average values taken for 50 mL aliquots, and error bars show one standard deviation for each set. As can be appreciated, the performance of the structure actually improved over time, at least for the time scale represented here of about 5 min.

Bacterial inactivation beyond 80-90% can be desirable for certain applications. A water sterilization device shows similar performance over a wide range of bacteria concentrations, from 10⁷ bacteria/mL to at least as low as 10⁴ bacteria/mL, and, therefore, multi-staged (e.g., three-staged), serial application of porous structures can be used to effectively reach inactivation efficiencies≧98%. FIG. 8(B) illustrates the performance of a porous structure for several different initial concentrations of Escherichia coli, from 10⁷ to 10⁴ bacteria/ml. For each experiment, 100 mL of bacteria solution was prepared by serial dilution from a 10⁷ bacteria/mL stock solution. Two plates were prepared for each experiment, one of treated and the other of untreated solution, and the inactivation efficacy was determined The structure showed similar performance over many orders of magnitude of bacterial density, indicating that serial treatment of a solution can reach low overall bacterial densities.

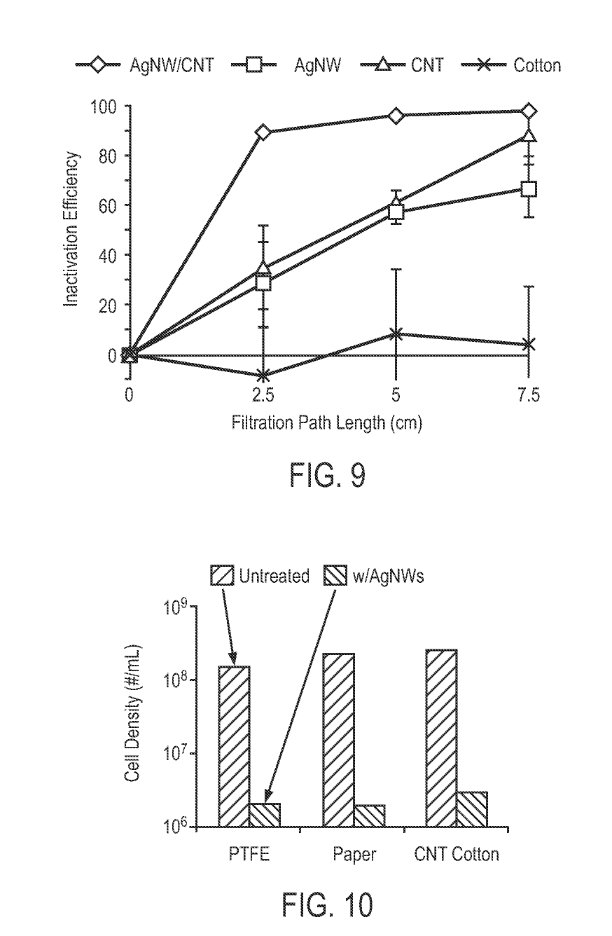

FIG. 9 illustrates inactivation efficacy for different filtration path lengths and four different porous structures: cotton with AgNWs and CNTs, cotton with AgNWs alone, cotton with CNTs alone, and cotton alone. By far the best performance was observed for the AgNW/CNT/cotton structure, which exceeded the ultimate performance of the other structures within one treatment stage and reached>98% bacteria inactivation after three stages. Both the CNT-only structure and the AgNW-only structure also exhibited antibacterial activity, albeit to a lesser degree. Each point in FIG. 9 represents an average inactivation efficiency for three 1 mL samples taken during the same experiment, and error bars indicate one standard deviation in each direction. The curve for the cotton-only structure dips below 0 because relatively large variations in plated cell densities for the highly concentrated plates yielded an average cell density for the first stage higher than that of the untreated samples.

### Example 3

### Characterization of Water Sterilization Device

In addition to providing electrical inactivation of bacteria, AgNWs can impart a passive resistance to biofouling. AgNWs can be incorporated into a variety of filters, without the need for chemical strategies for coupling to interior surfaces. Filters of the relevant scale for bacteria filtration typically have pores small enough such that AgNWs can become mechanically entangled by filtering a AgNW solution through the filters. In addition to a CNT-coated cotton, two different filters were so treated, one an ashless paper filter (Grade 42 available from Whatman Ltd.) with a pore size of 2.5 μm, and the other a tortuous poly(tetrafluoroethylene) (“PTFE”) filter with a pore size of 5 μm (available from Millipore). In order to test the antibacterial effectiveness of AgNWs, each structure was inoculated with bacteria by passing a bacterial solution through and then placing in media overnight at 37° C., after which an optical density at 600 nm was measured to assess bacterial density. As illustrated in FIG. 10, the results show that structures without AgNWs, including CNT-only cotton, showed a robust growth of bacteria, while the bacterial density in the solutions incubated with AgNW-containing structures was reduced to the detection limit of an absorbance system used, which represents at least a two to three orders of magnitude reduction. Representative plates were prepared from undiluted solutions for the filters without AgNWs and with AgNWs. No cells were observed for the AgNW-containing filters, so the actual order of magnitude reduction in bacterial density can be as large as seven orders of magnitude.

In order to investigate the intrinsic antibacterial activity of AgNWs, a standard Kirby-Bauer approach was used. Agar plates were prepared and inoculated with Escherichia coli, then a film of AgNWs was applied to the plate using a AgNW-treated PTFE filter as a mechanical stamp. If the AgNWs dissolve and release Ag⁺ ions, a region near the AgNW film with little or no bacterial growth is expected. In these studies, bacteria grew all the way up to the AgNW-treated area, but not inside, indicating that there is little dissolution from the AgNW film. An AgNW/CNT/cotton structure was also tested, and a small bacteria-free region of about 2 mm was observed, indicating that a small amount of silver dissolution can occur.

### Example 4

### Characterization of Water Sterilization Device

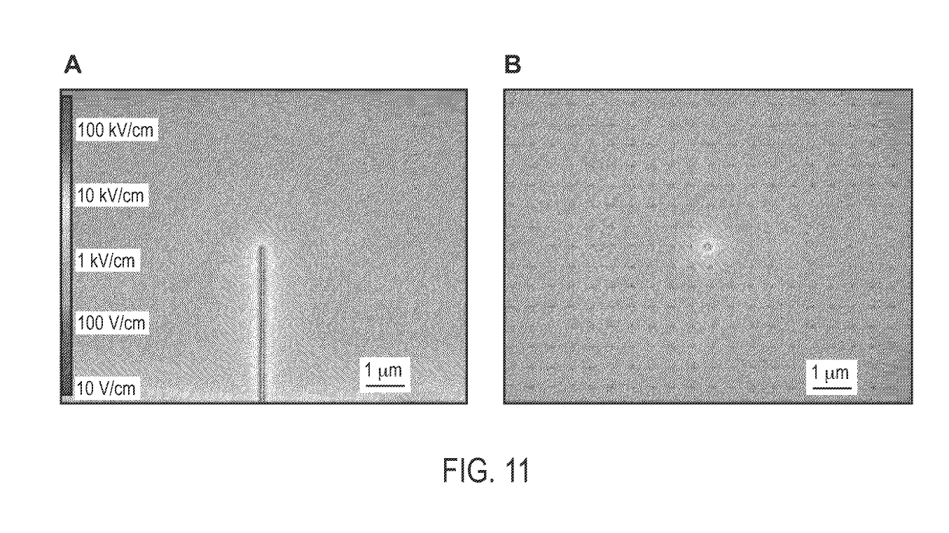

The local environment around AgNWs during electrical operation was investigated with finite element simulations using experimentally measured currents and voltages. At +20 V, a device draws 3 mA of current, representing a low power consumption of 60 mW, or 200 J/L at the measured flow rate. For comparison, a typical ultrafiltration membrane running at 130 psi and a flow rate of 1 L/hr can consume about 250 mW or 1 kJ/L. A simulation of the electric field around a nanowire protruding perpendicularly from a flat surface in 1 mM NaCl solution is illustrated in FIG. 11(A). A counter electrode has been placed in the solution 2 cm apart from the nanowire, and a +20 V potential difference has been applied. A transient simulation using the Nernst-Planck equations with electroneutrality was carried out. The anodic evolution of O₂ is simulated at the nanowire and the surface from which the nanowire protrudes.

More particularly, the simulation was carried out using the COMSOL Multiphysics Finite Element software package, using the Nernst-Planck, time-dependent application mode in the Chemical Engineering module. This application mode solves the combined transport equations. Simulation of anodic production of oxygen and chlorine at the nanowire surface was simulated for cases with and without flow. For the case without flow as illustrated in FIG. 11(A), a rectangular zone 2 cm tall and 20 μm wide and 20 μm thick was modeled, with a 4 μm long and 60 nm wide and 60 nm thick nanowire placed on the bottom edge with its long axis aligned with the model's long axis. The long edges of the model were set to 0 ion flux for three modeled ions, namely Na⁺, Cl⁻, and H⁺, corresponding to a symmetric boundary condition. The bottom edge, including the nanowire surface, was allowed to react with the ions according to the following two equations for O₂ evolution and Cl₂ evolution. At the top surface, concentrations for Na⁺ and Cl⁻ ions were fixed at 1 mM, and concentration for H⁺ ions was fixed at 10⁻⁷ M. The voltage of the top surface was linearly ramped up to the desired voltage, namely +20 V, over the course of 1 min, easing the calculation difficulty at each incremental time step.

$${j}_{{O}_{2}} = {k}_{{O}_{2}} ( exp ( - \frac{F * ( V - {E}_{{O}_{2}}^{0} )}{2 RT} ) - \frac{{C}_{{H}^{+}}}{{C}_{{H}^{+} , bulk}} exp ( \frac{F * ( V - {E}_{{O}_{2}}^{0} )}{2 RT} ) )$$

$${j}_{{Cl}_{2}} = {k}_{{Cl}_{2}} ( \frac{{C}_{{Cl}^{-}}}{{C}_{{Cl}^{-} , bulk}} exp ( - \frac{F * ( V - {E}_{{Cl}_{2}}^{0} )}{2 RT} ) - exp ( \frac{F * ( V - {E}_{{Cl}_{3}} )}{2 RT} ) )$$

For the case in which flow is simulated as illustrated in FIG. 11(B), the conditions were similar to that of the static case, except that the modeled area was a 0.6 cm long rectangle, with a single nanowire of 60 nm circular cross-section in the center, and with the nanowire long axis perpendicular to the simulated plane. In order to accurately account for ionic flow around the nanowire, the simulation geometry was selected so that the nanowire extends in the z direction, namely outside of the simulation plane. The nanowire surface has the same boundary conditions as in the static simulation, and the top and bottom surfaces are set to the zero flux condition. A flow rate of 1 L/hr is imposed in the +x direction on all three simulated ionic species. The left edge of the simulation is set to zero current and for convective flux alone. The right edge concentrations for Na⁺ and Cl⁻ ions were fixed at 1 mM, and the concentration for H⁺ ions was fixed at 10⁻⁷ M. The voltage was similarly linearly raised over 1 min to +20 V. Table 1 below sets forth various material characteristics and reaction constants used in the finite element simulation.

TABLE 1

| Name: Symbol | Value |
|---|---|
| Sodium Ion Diffusivity | 1.33*10⁻⁹ m²/s |
| Chlorine Ion Diffusivity | 9.31*10⁻⁹ m^{2/}s |
| Hydrogen Ion Diffusivity | 2.03*10⁻⁹ m²/s |
| Equilibrium Potential: E_{O}_{₃}⁰ | 1.23 V |
| Equilibrium Potential: E_{Cl}_{₂}⁰ | 1.35 V |
| Exchange Current Density: k_{O}_{₂} | 1*10⁻⁶ A/m² |
| Exchange Current | 10 A/m² |
| Density: k_{Cl}_{₂} | |

As observed in the simulation, the electric field intensity along the edges of the nanowire is extremely high, reaching in excess of 100 kV/cm. FIG. 11(B) illustrates the results of the simulation, in which a flow rate of 1 L/hr in the positive x direction has been imposed on the solution. The electric field intensity more than 5 nm from the nanowire surface is not noticeably affected by the applied flow condition; however, the maximum intensity at the nanowire surface reaches in excess of 1,000 kV/cm. The pH in the vicinity of the nanowire surface is significantly altered at this large applied voltage, dropping to as low as 3, which can have an impact on bacterial viability. Experimentally, the bulk pH of the solution was relatively unchanged after filtration.

While the invention has been described with reference to the specific embodiments thereof, it should be understood by those skilled in the art that various changes may be made and equivalents may be substituted without departing from the true spirit and scope of the invention as defined by the appended claims. In addition, many modifications may be made to adapt a particular situation, material, composition of matter, method, or process to the objective, spirit and scope of the invention. All such modifications are intended to be within the scope of the claims appended hereto. In particular, while the methods disclosed herein have been described with reference to particular operations performed in a particular order, it will be understood that these operations may be combined, sub-divided, or re-ordered to form an equivalent method without departing from the teachings of the invention. Accordingly, unless specifically indicated herein, the order and grouping of the operations are not limitations of the invention.

What is claimed is:

1. A water sterilization device comprising:
a conduit including an inlet to provide entry of untreated water and an outlet to provide exit of treated water;
a porous electrode housed in the conduit and disposed between the inlet and the outlet, the porous electrode including a porous support and nanostructures coupled to the porous support; and
an electrical source coupled to the porous electrode.

2. The water sterilization device of claim 1, wherein the porous electrode has a sheet resistance that is no greater than 500 Ω/sq.

3. The water sterilization device of claim 2, wherein the sheet resistance is no greater than 10 Ω/sq.

4. The water sterilization device of claim 1, wherein the porous support has a pore size in the μm range.

5. The water sterilization device of claim 4, wherein the pore size is in the range of 50 μm to 300 μm.

6. The water sterilization device of claim 1, wherein the porous support includes a fibrous material.

7. The water sterilization device of claim 6, wherein the fibrous material corresponds to a textile.

8. The water sterilization device of claim 1, wherein at least a subset of the nanostructures is electrically conductive or semiconducting.

9. The water sterilization device of claim 8, wherein the subset of the nanostructures corresponds to carbon nanotubes.

10. The water sterilization device of claim 1, wherein at least a subset of the nanostructures is antimicrobial.

11. The water sterilization device of claim 10, wherein the subset of the nanostructures corresponds to silver nanowires.

12. The water sterilization device of claim 1, wherein the nanostructures include carbon nanotubes and silver nanowires.

13. The water sterilization device of claim 1, further comprising a counter electrode housed in the conduit and spaced apart from the porous electrode, and the electrical source is coupled to the counter electrode to apply a voltage difference between the porous electrode and the counter electrode.

14. The water sterilization device of claim 1, wherein the porous electrode corresponds to a first porous electrode, and further comprising a second porous electrode housed in the conduit and spaced apart from the first porous electrode, and the electrical source is coupled to the second porous electrode to apply a voltage difference between the first porous electrode and the second porous electrode.

15. The water sterilization device of claim 14, further comprising a separator disposed between the first porous electrode and the second porous electrode.

16. A method of sterilization, comprising:
providing a fibrous material and nanostructures coupled to the fibrous material, at least one of the nanostructures including a metal and having an aspect ratio that is at least 5; and
passing a fluid stream through the fibrous material, so as to at least partially sterilize the fluid stream based on exposure to the nanostructures.

17. The method of claim 16, wherein the metal corresponds to one of copper, nickel, and silver.

18. The method of claim 16, wherein the nanostructures include silver nanowires.

19. The method of claim 16, wherein the fibrous material and the nanostructures correspond to a porous electrode, and further comprising subjecting the fluid stream to an electric field by applying a voltage to the porous electrode.

20. The method of claim 16, wherein passing the fluid stream is carried out at a flow rate in the range of 50,000 L/(hr m²) to 200,000 L/(hr m²).
